(19) United States
(12) Patent Application Publication
(10) Pub. No.: US 2011/0085582 A1
(43) Pub. Date: Apr. 14, 2011

(54) METHOD FOR STUDYING THE SURFACE COMPOSITION OF PLANAR STRUCTURES

(75) Inventors: Bernhard Zagar, Linz (AT); Florian Maier, Leanding (AT)

(73) Assignee: PLFINGER SYSTEMS GMBH

(21) Appl. No.: 12/734,700

(22) PCT Filed: Nov. 19, 2008
(86) PCT No.: PCT/EP2008/065810

§ 371 Date: Aug. 3, 2010

(30) Foreign Application Priority Data
Nov. 20, 2007 (AT) A 1881/2007

(51) Int. Cl. G01N 25/00

(52) U.S. Cl. 374/9

(57) ABSTRACT

The invention relates to a method for studying the surface composition of planar structures (1), wherein specific surface areas are first heated continuously in a controlled way by a heat source (2), which is moved along the surface, and a temperature measurement is performed after a predetermined time, in order to determine the cooling behavior. High precision can be achieved in that the surface areas which are heated by the heat source (2) are detected at multiple moments by a thermal imaging camera (3), in order to prepare a temperature profile of individual surface points. Furthermore, the present invention relates to a device for performing the method.

The invention relates to a method for examining the surface composition of planar structures, in which specific surface areas are first heated continuously in a controlled way by a heat source and a temperature measurement is performed after a predetermined time in order to determine the cooling behavior, in that the surface areas which are heated by the heat source are detected at multiple moments by a thermal imaging camera in order to prepare a temperature profile of individual surface points.

The term “surface composition” shall be understood above and below in the respect that not only the direct surface is examined, but it is also possible to analyze a multi-layer surface structure in an in-depth manner. These are for example several layers of lacquer on a hull, including any air bubbles disposed beneath the same.

It is necessary in many areas of technology to examine the state of surfaces of components that have a large surface area in order to enable performing subsequent machining processes in a purposeful manner. For example, the hull of ships must be protected in certain intervals against corrosion. For this purpose, old defective coatings are removed in special processes in order to provide the cleaned steel surfaces of the hull of the ship with a new coat of paint. This method is known as “recoating”. The manual performance of this process is very labor-intensive and is hazardous to the health of all persons involved. It is therefore desirable to automate the process in that the removal occurs by a specially constructed robot arm, at the end of which there is a cleaning head which is also equipped with a lacquer thickness sensor in addition to the cleaning tools in order to check the complete removal.

It is known to determine the surface composition, and especially the lacquer thickness, in such a way that the workpiece surface is heated in a spatially limited way and the cooling behavior is determined by a temperature measurement. Solutions of this kind are known from DE 32 48 157 A, DE 37 10 825 A or EP 1 132 736 A. In these methods, a measuring head is generally moved with a predetermined speed over the surface to be examined, with a heat source on the one hand and a temperature sensor on the other hand being provided on the measuring head. The temperature sensor which is arranged at a spatial distance behind the heat source in the direction of movement allows determining the cooling behavior, from which conclusions can be drawn on the surface composition, so that especially the thickness of any remaining layers of lacquer can be detected.

It has been noticed that the known methods are not precise enough in order to ensure a satisfactory automated processing of surfaces such as the hulls of ships. Moreover, the detection of the layer thickness only occurs in a punctiform manner, so that the significance is limited.

A method is known from US 2006/0262971 A in which a thermal imaging camera is used to draw conclusions on the composition of a component from the cooling behavior of a component. The measuring area is limited to the image field of the thermal imaging camera as a result of the static arrangement, so that larger components cannot be examined, or only in an unsatisfactory way.

It is the object of the present invention to avoid such disadvantages and to provide a method with which workpiece surfaces can be examined in a quick and efficient way, with a high spatial resolution both in the direction of the surface and in the depth as well as a high amount of discernability being achievable.

These objects are achieved in such a way that the heat source is moved with a movement speed v over the surface, the thermal imaging camera covers a length area of length s in the direction of movement, the time interval for performing the measurements with the thermal imaging camera is t₀ in each case, and further the time interval t₀ is less than 10%, preferably less than 5%, of the ratio of length s to the speed of movement.

The invention allows achieving a spatial resolution in all dimensions which is better than 0.5 cm. The measurement usually occurs with a feed speed of approx. 0.1 m/s and a distance of the thermal imaging camera to the sample of 40 cm. First tests have shown that more than 95% of the residual fields can be detected in a secure way. Residual fields are areas to which coating residues adhere. Further improvements can be expected here by more precise adjustment. The advantageous aspect in the present invention is that the scanning occurs in a planar way, which increases the significance accordingly.

A further relevant aspect of the present invention is the measurement of the layer thickness. It is thus possible to gain further relevant information in practice. The thickness and/or the number of layers to be applied can be set during the recoating of hulls depending on the detected thickness of the layers that are still intact, leading to considerable savings in material.

An especially high measuring precision is achieved especially by the movement of the thermal imaging camera, which can be expressed as follows by numbers:

t₀<0.1·s/v,

preferably

t₀<0.05·s/v.

It has been noticed that any disturbance variables thus have a relatively low influence on the result of the measurement.

An especially advantageous embodiment of the method in accordance with the invention provides that for calculating the surface a characteristic cooling time constant t is calculated. It has been noticed that the characteristic cooling time constant, which will be explained below in closer detail, is an especially good measure for the surface composition.

The present invention further relates to an apparatus for examining the surface composition of planar structures, comprising a heat source, a device for moving the heat source along the surface of the structure and a measuring device for detecting the surface temperature of the structure which is connected with the device for moving the heat source. It is provided in accordance with the invention that the measuring device is arranged as a thermal imaging camera which is arranged to perform repeated measurements of areas of the surface subjected to heat source, with the respective measuring areas overlapping.

Preferably, the heat source is arranged as a halogen lamp or as an arrangement of several halogen lamps. It is also possible to use elongated and very slender infrared radiators.

It is especially advantageous when the thermal imaging camera is arranged as an infrared camera with a resolution of at least 240×320 pixels. A resolution in the magnitude of 1 mm can be achieved when using a suitable optical system and a respective recording distance.

The present invention will be explained below in closer detail by reference to the illustrated embodiments, wherein:

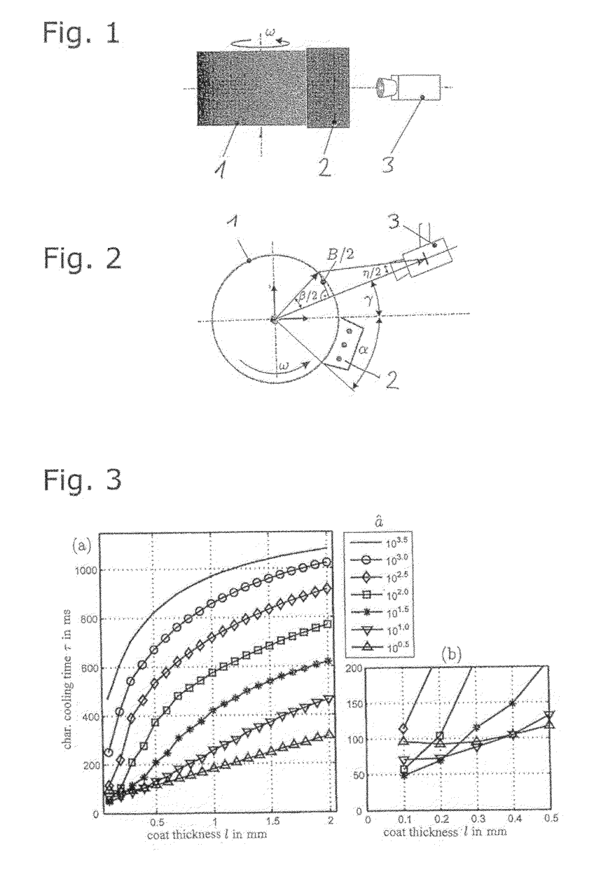

FIG. 1 shows a side view of a test arrangement;

FIG. 2 shows a top view of the arrangement of FIG. 1, and

FIG. 3 shows diagrams for illustrating the measurement results.

The following needs to be noted generally at first:

Information on the principle of heat transfer (conduction, convection and radiation) and thermography was collected. Radiation is emitted by bodies, with the radiation intensities depending to a substantial extent on the absolute temperature of the body. Conduction describes the thermal conduction in the material. In order to enable quantifying these heat transport processes, extensive knowledge on the properties of materials is necessary. The properties concerning the degree of emission, thermal conductivity, thermal diffusity coefficient, thermal capacity and density of different steels and base materials for lacquers were collected subsequently. It was noticed that these data for steels are relatively easily accessible and reliable, but that in contrast to this there are hardly any characteristic values for lacquers. For this reason it is necessary to use the properties of the base materials of the lacquers. Concerning the emissivity it is only possible to make rough statements because they depend to a high extent on the surface. There is usually a large difference between the emissivity of lacquers (around 0.9) and of steel (between 0.2 and 0.6). Emissivity can be applied only within limits to the degree of absorption of a surface, so that measurement methods on this basis provide only unsatisfactory results.

Thermal conduction occurs as a result of a temperature gradient present in the material. The general equation of thermal conduction (equation 1) describes this process concerning the three directions of space x, y and z, and time t. For a one-dimensional problem without any internal heat sources, the law on thermal conduction is obtained according to equation (2) with the independent variables x and t. The thermal diffusity coefficient is obtained as follows:

$$\begin{matrix}a = \frac{k}{ρ \cdot {c}_{p}} . & \\ \frac{\partial }{\partial x} ( k \frac{\partial T}{\partial x} ) + \frac{\partial }{\partial y} ( k \frac{\partial T}{\partial y} ) + \frac{\partial }{\partial z} ( k \frac{\partial T}{\partial z} ) + \dot{q} = ρ \cdot {c}_{p} \frac{\partial T}{\partial t} & ( 1 ) \\ \frac{1}{ρ \cdot {c}_{p}} [ \frac{\partial k}{\partial x} \frac{\partial T}{\partial x} ] + a \frac{{\partial }^{2} T}{\partial {x}^{2}} = \frac{\partial T}{\partial t} & ( 2 )\end{matrix}$$

with the terms meaning the following:
k

$$[ \frac{W}{m K} ]$$

thermal conductivity
p

$$[ \frac{kg}{{m}^{3}} ]$$

specific density
cₚ

$$[ \frac{J}{kg K} ]$$

specific thermal capacity
\dot{q}

$$[ \frac{W}{{m}^{3}} ]$$

heat quantity generated per unit of volume unit of time
a

$$[ \frac{{m}^{2}}{s} ]$$

thermal diffusity coefficient

The three-dimensional problem of equation 1 is simplified in equation 2 by omitting the comparatively small terms in order to enable a self-contained solution.

A model for one-dimensional equation of thermal conduction was prepared on the basis of these equations, which model was used as the basis for simulation with a software for solving mathematical problems (Matlab). The results of the simulation confirm the expectations concerning absorption and thermal conduction. As a result of the high amount of uncertainty concerning the characteristic values of the material it was important to move to experimental investigations.

A measuring assembly was developed for performing first tests on the performance of the method in accordance with the invention which is shown schematically in FIGS. 1 and 2. A cylindrical sample with different surface compositions is used, which is designated with reference numeral 1. The sample is moved past a fixed arrangement of very slender infrared radiators 2 and then scanned by an infrared camera 3 as a thermal imaging camera. The surfaces of the samples are lacquered in different compositions, sandblasted completely, sandblasted only slightly, with the lacquering being performed in different lacquer layer thicknesses with different defective places in the lacquer.

In the course of the development of the method in accordance with the invention, an estimator was developed for the characteristic cooling time constant \hat{τ}.

The model (2) was further simplified in order to derive a suitable estimator for the characteristic cooling time constant \hat{τ}. For this purpose, the following assumptions were made: Firstly, the heating occurs in an impulse-like way and at the end of the impulse the entire energy supplied by radiation is still in the lacquer layer. Secondly, there is no further exchange of energy on the lacquer surface after heating. And thirdly, the temperature of the carrier material T_{∞} remains constant during the cooling because the carrier material has high thermal conductivity on the one hand and high thermal capacity on the other hand.

With the assumptions made, the heat transfer (lacquer layer to colder carrier material) can be described with a conventional homogeneous differential equation.

The solution for the surface temperature T(t) is then:

T(t)=T_{A}·e^{-(t-t}^{₁}^{)τ}^{₁}+T_{∞}, (2a)

with T_{A} stating the temperature difference between lacquer and carrier material directly after the heating, T_{∞} the constant assumed temperature of the carrier material, t₁ the time length of the heating impulse and τ the cooling characteristics.

The calculation of the estimator occurs according to the following formula (3):

$${\hat{τ}}_{( ϕ p , z )} = \frac{{\sum }_{m = 1}^{M} ( {s}_{( ϕ p , z )} [ m ] - {s}_{( ϕ p , z )} [ M ] )}{( {s}_{( ϕ p , z )} [ 1 ] - {s}_{( ϕ p , z )} [ M ] ) {f}_{rate}} \qquad ( 3 )$$

In this equation, M states the number of measured values of the available measured data s[m] and fᵣₐₜₑ the refresh rate of the thermal imaging camera.

The indexes ((φₚ z) state the location on the material sample from where the measured data s[m] originate.

The influence of the material parameters such as thermal diffusity coefficient a and layer thickness l on the characteristic cooling constant τ was examined by simulating the thermal conductivity processes which are performed with a block composed of a lacquer layer (index L) and metal plate (index Fe). The ratio of the thermal diffusity coefficients

$$\hat{a} = \frac{{a}_{Fe}}{{a}_{L}} \qquad ( 4 )$$

was considered for the range â={3, . . . , 3200}. In the above equation (4), a_{Fe} states the thermal diffusity coefficient of steel and a_{L} the thermal diffusity coefficient of the layer disposed above the same (lacquer). The examination showed that there is a non-linear connection between τ and thickness l and its properties are clearly influenced by the ratio of the thermal diffusity coefficients â.

In order to ensure that the maximum possible sensitivity in the allocation of thickness l and the characteristic cooling time constant τ=f(l), the length of the excitation phase t₁ is adjusted to the current values for the thickness and the thermal diffusity coefficient a_{L} of the uppermost layer. The transit time t_{N} which is calculated with the equation

$${t}_{1} = {t}_{N} \approx 0 , 36 \frac{{l}^{2}}{{a}_{L}} \qquad ( 5 )$$

has proven to be a suitable choice for the duration of the excitation phase. As can be seen, the length of the excitation phase t₁ depends by square on the thickness l and conversely proportional on the thermal diffusity coefficient a_{L} which is calculated from the thermal conductivity k_{L}, the density ρ_{L} and the thermal capacity c_{L} of the layer with the equation

$${a}_{L} = \frac{{k}_{L}}{{ρ}_{L} {c}_{L}} . \qquad ( 6 )$$

The result of the simulation is shown in FIG. 3. (a) shows the layer thickness l entered against the characteristic cooling time constant τ for different ratios of the thermal diffusity coefficients â (â={100.5, . . . , 10^{3.5}}). (b) shows of (a) the value range l={0, . . . , 0.5} mm and τ={0, . . . , 200} ms on an enlarged scale. One can clearly see the ambiguity of the graphs with â={100.5, 10¹} that occur in this value range. As is shown in FIG. 3, an increasingly growing offset is superimposed on the graphs with increasing ratio of the thermal diffusity coefficients â.
The magnitude of the offset which is superimposed on the graphs of FIG. 3 increases with rising ratio of the thermal diffusity coefficients â.
As is shown in FIG. 3, there is a non-linear connection between the thickness l and the characteristic cooling constant τ.
Although the connection is non-linear, it rises in a strictly monotonous way over larger areas, so that a distinct allocation of the thickness l to the characteristic cooling time constant τ is given.

It is an important point of the illustrated simulation result that all graphs rise in a strictly monotonous way with two exceptions (â={3, 16, 10}) and therefore enable a distinct statement on the thickness. Better measurement results can be achieved when the thermal diffusity coefficient a_{L} of the lacquer layer is much smaller than that of the carrier material (metal plate). The chosen duration of the excitation phase t₁ is interesting for the reason that a too short interval will distort the result.

It was examined within the scope of this milestone how the properties of the thermal imaging camera influence the measurement of the layer thickness. In particular, it was examined whether an improvement of the system properties can be achieved with changes made to the spatial resolution, temperature resolution, refresh rate or duration of exposure of the thermal imaging camera.
A higher spatial resolution of the thermal imaging camera is insufficient to increase the spatial resolution of the layer thickness sensor. An improvement in the spatial resolution is only achieved when the refresh rate of the thermal imaging camera increases or the relative speed between material sample and sensor decreases.
This is due to the reason that the local distance between two successive pixels (in the direction of movement) is obtained from the quotient of the relative speed v and the refresh rate fᵣₐₜₑ.
The better temperature resolution of the thermal imaging camera influences the signal-to-noise performance ratio, leading to a lower estimation variance of the characteristic cooling time constant τ and thus the wanted layer thickness.
The employed thermal imaging camera has a duration of exposure of approx. 20 μs. It needs to be considered for the choice of the maximum relative speed, so that an area not covered by a camera pixel will not intersect with adjacent pixel areas (smudging).

The measurement system used for the measurement has already been discussed briefly. The geometrical arrangement of the sensor components is shown in detail in FIGS. 1 and 2 in the form of a diagram. The principal arrangement of the components is shown in a general view and the associated plan view. The employed infrared camera from NEC has a temperature resolution of 80 mK, a pixel number of 320×240 pixels and a maximum refresh rate of 30 Hz. During the measurement, the camera is connected by means of a powerful bus system to a PC where the image data are further processed. The power required for the excitation is produced by three halogen lamps 8 in the form of slender line sources, which each consume 1.5 kW of electric power. The samples to be measured are disposed on the rotation table of the so-called demonstrator. The angular speed w can be set to between 0 and ≈1.5π rad/s, which leads to a maximum circumferential speed of vₘₐₓ≈0.94 m/s at a sample radius of r=20.5 cm.

Typical values for setting the parameters for the layer thickness measurement are shown in Table 1.

| Variable | Name | Value | Unit |
|---|---|---|---|
| R | Sample radius | 20.5 | cm |
| V | Measurement speed | 11.2 | cm/s |
| fᵣₐₜₑ | Refresh rate | 30 | Hz |
| α | Circumferential angle (lamp) | 0.53 | rad |
| β | Picture angle (IR camera) | 0.62 | rad |
| γ | Position of objective axis (IR camera) | β/2 | rad |
| ω | Angular velocity | 0.55 | rad/s |

The settings stated in Table 2 were made for the recognition of the residual field.

| Variable | Name | Value | Unit |
|---|---|---|---|
| R | Sample radius | 20.5 | cm |
| V | Measurement speed | 37.1 | cm/s |
| fᵣₐₜₑ | Refresh rate | 30 | Hz |
| α | Circumferential angle (lamp) | 0.53 | Rad |
| β | Picture angle (IR camera) | 0.62 | Rad |
| γ | Position of objective axis (IR camera) | β/2 | Rad |
| ω | Angular velocity | 1.81 | rad/s |

The present invention allows detecting the thickness of the layers of lacquer and other surface compositions of workpieces with high precision in an automatic manner and at high relative speeds.

1. A method for examining the surface composition of planar structures (1), in which specific surface areas are first heated continuously in a controlled way by a heat source (2) and temperature measurements are performed after a predetermined time in order to determine the cooling behavior, in that the surface areas which are heated by the heat source (2) are detected at multiple moments by a thermal imaging camera (3) in order to prepare a temperature profile of individual surface points, wherein the heat source is moved with a movement speed v over the surface, the thermal imaging camera (3) covers a length area of length s in the direction of movement, the time interval for performing the measurements with the thermal imaging camera (3) is t₀ in each case, and further the time interval tₒ is less than 10%, preferably less than 5%, of the ratio of length s to the speed of movement v, i.e.
t₀<0.1·s/v,
preferably
t₀<0.05·s/v.

2. The method according to claim 1, wherein for evaluating the surface at least one characteristic cooling time constant τ is calculated.

3. An apparatus for examining the surface composition of planar structures (1), comprising a heat source (2) and a measuring device (3) arranged as a thermal imaging camera (3) for detecting the surface temperature of the structure (1) which is connected with the device for moving the heat source (2) and which is arranged to repeatedly perform measurements of areas of the surface which are subjected to the heat source (2), including a device for moving the heat source (2) along the surface of the structure in order to cover several measuring areas, with the respective measuring areas overlapping, and the thermal imaging camera (3) has a refresh rate (fᵣₐₜₑ) which is determined in such a way that the time interval for performing the measurements with the thermal imaging camera (3) is t₀ in each case, and further the time interval t₀ is less than 10%, preferably less than 5%, of the ratio of the length s to the speed of movement v, i.e.
t₀<0.1·s/v,
preferably
t₀<0.05·s/v.

4. The apparatus according to claim 3, wherein the heat source is at least one halogen lamp.

5. The apparatus according to claim 4, wherein the at least one halogen lamp is arranged in the manner of a rod.

6. The apparatus according to claim 5, wherein the heat source (2) is at least one infrared radiator.

7. The apparatus according to claim 3, wherein the thermal imaging camera (3) is an IR camera with a resolution of at least 240×320 pixels.
